(19) United States
(12) Patent Application Publication
(10) Pub. No.: US 2006/0092100 A1
(43) Pub. Date: May 4, 2006

(54) Display controlling device and controlling method

(75) Inventor: Yu Pin Chou, Tongxiao Town (TW)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: REALTEK SEMICONDUCTOR CORPORATION, Hsin Chu Hsien (TW)

(21) Appl. No.: 11/265,126

(22) Filed: Nov. 3, 2005

(30) Foreign Application Priority Data
Nov. 4, 2004 (TW) 093133650

(51) Int. Cl. G09G 3/20; H04N 3/14

(52) U.S. Cl. 345/55; 348/792

(57) ABSTRACT

A method is applied to a display controller and can make the display controller compatible with various display panels by adjusting the pulse cycles of the vertical synchronous display signal or the horizontal synchronous display signal of the display controller.

### CROSS REFERENCE TO RELATED APPLICATION

This application claims the priority benefit of Taiwan Patent Application Serial Number 093133650, filed on Nov. 4, 2004, the full disclosure of which is incorporated herein by reference.

### BACKGROUND OF THE INVENTION

1. Field of the Invention

This invention generally relates to a display device, and more particularly to an apparatus and method for changing the frame period in a display device.

2. Description of the Related Art

In a liquid crystal display (LCD) system, the LCD controller is an important element for generating essential image control signals to the LCD panel and for transforming the format of an input image data signal into an appropriate one so as to be displayed on the LCD panel. Generally, the image signal includes a plurality of control signals and an image data signal (DATA), wherein the control signals include a data enable signal (DEN), a clock signal (CLK), a horizontal synchronization signal (HS) and a vertical synchronization signal (VS).

The LCD controller can be used for transforming the format of an input image data signal into an appropriate one, for example, transforming a low resolution (e.g. 800×600) image signal into a high resolution (e.g. 1024×768) image signal. The conventional method has disclosed that there is a specific relation existing between the output clock signal DCLK and the input clock signal ICLK such that the output clock signal DCLK cannot be adjusted for meeting the requirements of various display panels, resulting in compatibility problem between the LCD controller and the display panels. In addition, any drift or jitter of the input control signal may cause the output control signal a drift or jitter.

### SUMMARY OF THE INVENTION

It is an object of the present invention to provide a method and apparatus, which utilize an adjustable control signal to solve the above-mentioned problem.

It is another object of the present invention to provide a method and apparatus, which can prevent a FIFO (first-in first-out) memory from overflow or underflow while an image control signal is adjusted.

It is a further object of the present invention to provide a display controller, in which an image control signal is adjustable such that the display controller can be compatible with various display panels thereby improving the compatibility in application.

One embodiment according to the present invention discloses a method, which is applied to a display controller for processing input image signals which include an input control signal and outputting output image signals which include an output synchronization signal having a first frequency. The method of the present invention comprises: delaying the output synchronization signal for a variable time according to a pattern such that the first frequency of the output synchronization signal is time-variable; and outputting the delayed output synchronization signal.

One embodiment according to the present invention further discloses a display controller for controlling a display panel, which comprises a display controller unit, a programmable timing generator and a multiplexer. The display controller unit is used for processing an image data and transmitting the image data to the display panel and for controlling a display rate of the image data on the display panel according to a first synchronization signal having a first time interval. The programmable timing generator is used for generating a second synchronization signal according to the first synchronization signal, wherein the second synchronization signal has at least one time interval different from the first time interval of the first synchronization signal. The multiplexer is used for receiving the first synchronization signal and the second synchronization signal and selectively outputting one of them to the display panel according to a control signal.

### BRIEF DESCRIPTION OF THE DRAWINGS

Other objects, advantages, and novel features of the present invention will become more apparent from the following detailed description when taken in conjunction with the accompanying drawings.

FIG. 1 illustrates a schematic circuit of a display controller, according to one embodiment of the present invention, for controlling a display panel.

FIG. 2 is a timing diagram of the input signals and the output signals in a display controller.

FIG. 3 is a schematic circuit view of a programmable timing generator according to one embodiment of the present invention.

FIG. 4 is a timing diagram for illustrating how to change the time interval of a vertical synchronization signal by controlling the pulse number of a horizontal synchronization signal.

FIG. 5 is a block diagram for illustrating the inner circuit of a display controller according to another embodiment of the present invention.

FIG. 6 is a schematic circuit of the timing control unit shown in FIG. 5.

FIG. 7 is a schematic view of a counter and its input signals.

### DETAILED DESCRIPTION OF THE PREFERRED EMBODIMENT

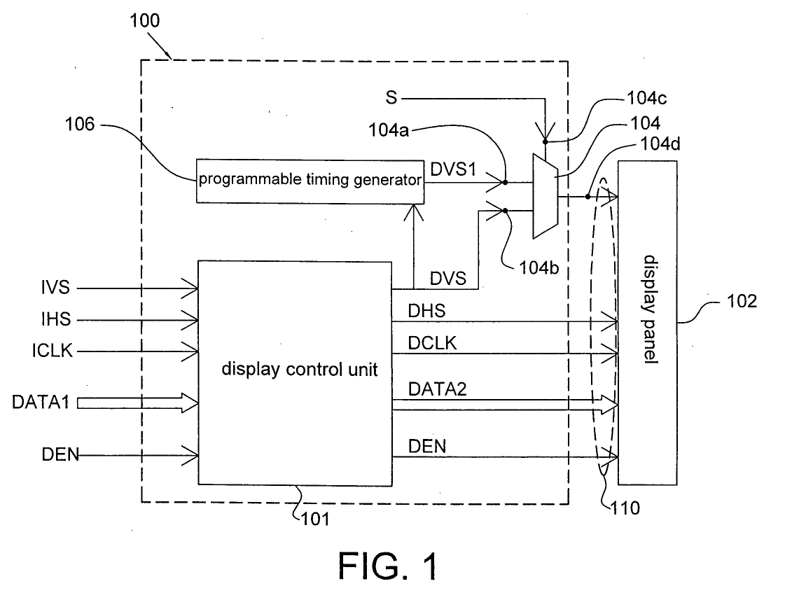

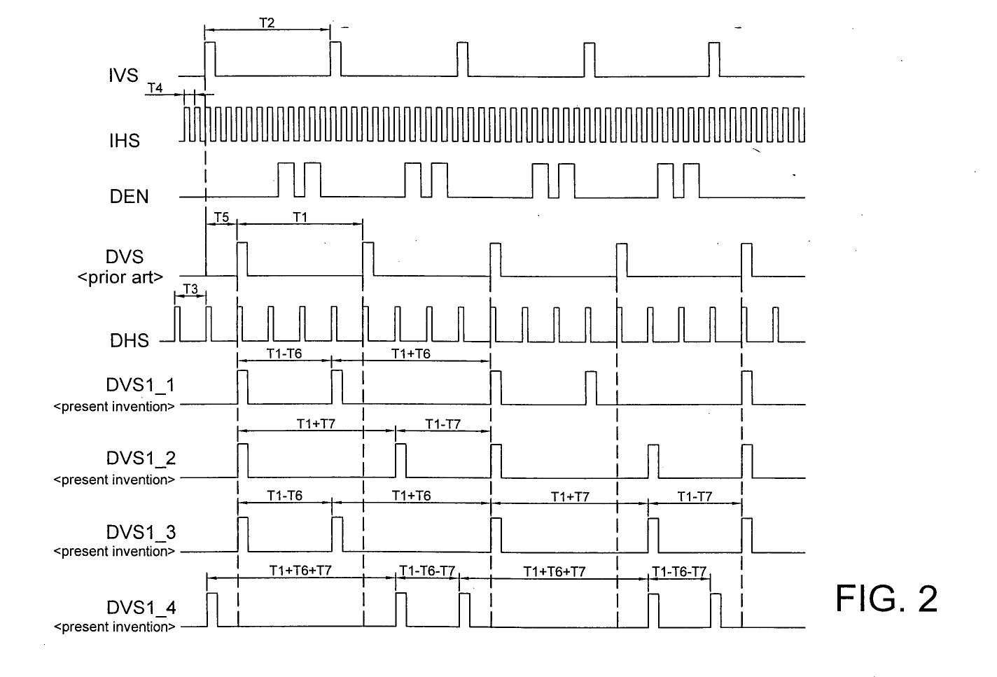

FIG. 1 illustrates a schematic circuit of a display controller 100, according to one embodiment of the present invention, for controlling a display panel 102. The display controller 100 is used for transforming the format of an input image data signal into an appropriate one and outputting the transformed image data signal to the display panel 102 through a display interface 110 such that the transformed image data signal can be displayed on the display panel 102. The display controller 100 comprises a display control unit 101. In an embodiment, when the display control unit 101 transforms an image data signal DATA1 into an image data signal DATA2, it also respectively transforms an input vertical synchronization signal IVS, an input horizontal synchronization signal IHS, an input data enable signal DEN and an input clock signal ICLK into a displayed vertical synchronization signal DVS, a displayed horizontal synchronization signal DHS, a displayed data enable signal DEN and a displayed clock signal DCLK. In the embodiment, the display interface 110 includes DATA2, DVS, DHS, DEN, and DCLK. In this embodiment, the display controller 100 further comprises a multiplexer 104 and a programmable timing generator 106. The programmable timing generator 106 can generate a displayed vertical synchronization signal DVS1 with different time interval T1 as shown in FIG. 2, according to the displayed vertical synchronization signal DVS (or the input vertical synchronization signal IVS). The displayed vertical synchronization signals DVS and DVS1 are respectively transmitted to the two inputs 104a, 104b of the multiplexer 104; the displayed vertical synchronization signal DVS1 can be outputted, through the output 104d, to the display panel 102 by the control of a selecting signal S at the select line 104c. In another embodiment, the display controller 100 further comprises a pattern generator for controlling the output of the programmable timing generator 106. The display interface 110 can be TTL, TTL_TCON, LVDS, RSDS_TCON, DEN only mode, DVS mode or DHS mode interface.

In prior art, the time interval T1 of the displayed vertical synchronization signal DVS and the time interval T2 of the input vertical synchronization signal IVS are the same, and the displayed vertical synchronization signal DVS has a fixed delay time T5 with respect to the input vertical synchronization signal IVS. The display controller of the present invention is capable of changing the time interval T1 of the displayed vertical synchronization signal DVS, that is, changing the frame period thereby solving the above-mentioned problems existing in the prior art.

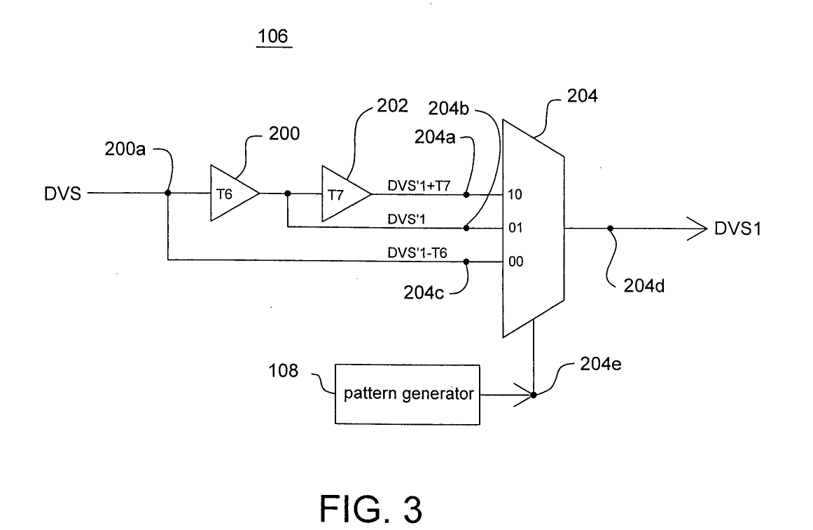

The programmable timing generator 106 can utilize many manners to generate the displayed vertical synchronization signal DVS1 with different time intervals. For example, as shown in FIG. 3, the programmable timing generator 106 comprises two delay elements 200, 202 and a multiplexer 204. The delay elements 200 and 202 respectively have a delay time T6 and T7. An input 200a of the delay element 200 receives the displayed vertical synchronization signal DVS. Since the displayed vertical synchronization signal DVS (=DVS1′-T6) passes the delay elements 200 and 202 and then is received by the input 204a of the multiplexer 204, the displayed vertical synchronization signal DVS received by the input 204a has been delayed for two delay times (DVS+T6+T7=DVS1′+T7). Similarly, the displayed vertical synchronization signal DVS received by the input 204b has been delayed for one delay time (DVS+T6=DVS1′). In addition, the input 204c of the multiplexer 204 directly receives the displayed vertical synchronization signal DVS (=DVS1′-T6). In this embodiment, the programmable timing generator 106 further has a pattern generator 108 for outputting a control signal to the select line 204e of the multiplexer 204 thereby selecting one of the displayed vertical synchronization signals at inputs 204a, 204b, 204c to be outputted. In this manner, the displayed vertical synchronization signals DVS1 with different time intervals can be generated as shown in FIG. 2. For example, if the pattern generator 108 alternatively outputs logic signals “00” and “01” to the select line 204e of the multiplexer 204, then the output 204d of the multiplexer 204 will output the waveform DVS1_1 as shown in FIG. 2. Similarly, if the pattern generator 108 alternatively output logic signals “01” and “10”, then the output 204d will output the waveform DVS1_2 as shown in FIG. 2. Similarly, if the pattern generator 108 alternatively output logic signals “00”, “01”, “10” and “01”, then the output 204d will output the waveform DVS1_3 as shown in FIG. 2. Similarly, if the pattern generator 108 alternatively output logic signals “00” and “10”, then the output 204d will output the waveform DVS1_4 as shown in FIG. 2. In other embodiment, the pattern generator 108 outputs a predetermined or a random or a pseudo-random pattern such that the average time interval of the displayed vertical synchronization signal DVS1 can be kept equal to T1, that is, an average of the frequency of the displayed vertical synchronization signal DVS1 is constant, and an average of the input frame period is substantially equal to an average of the output frame period.

In another embodiment, a predetermined pattern outputted from the pattern generator 108 can be defined and set by a designer; that is, the displayed vertical synchronization signal DVS1 is adjustable such that the display controller 100 can be compatible with various display panels thereby improving the compatibility in application.

It should be understood that the programmable timing generator 106 as shown in FIG. 3 is only for illustration and should not be limited to this embodiment. Any other circuit providing a displayed vertical synchronization signal DVS1 with variable time interval can also achieve the same object.

In another embodiment, changing the time interval of the displayed vertical synchronization signal DVS can also be achieved by directly controlling the inner timing of the display control unit 101. For example, the display control unit 101 includes the programmable timing generator 106.

In other embodiments of the present invention, changing the time interval of the displayed vertical synchronization signal DVS is achieved by controlling the pulse number of the input horizontal synchronization signal IHS, the input clock signal ICLK, the displayed horizontal synchronization signal DHS or the displayed clock signal DCLK within the display control unit 101.

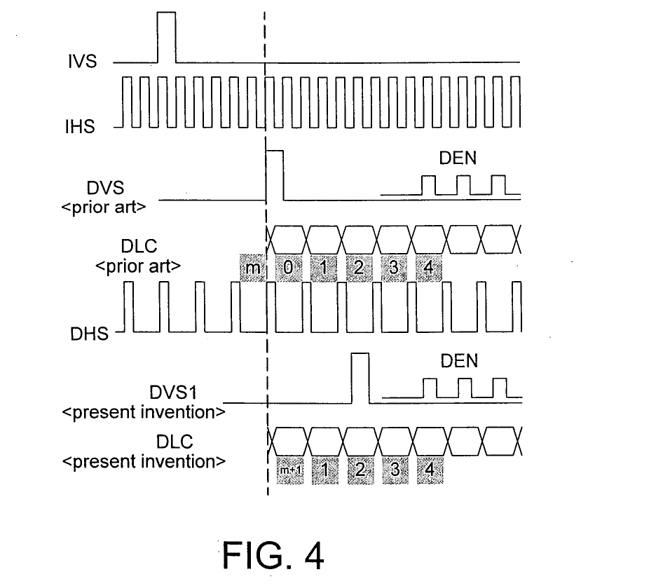

FIG. 4 is a timing diagram for illustrating how to change the time interval of the displayed vertical synchronization signal DVS by controlling the pulse number of the displayed horizontal synchronization signal DHS. In this embodiment, it is assumed that one pulse of the displayed vertical synchronization signal DVS occurs while a display line counter (DLC) counts to m, and the next one pulse of the displayed vertical synchronization signal DVS will occur while the display line counter DLC recounts from zero to m. In this embodiment, the data enable signal DEN occurs while the display line counter DLC counts to 3. The present invention can change the time interval of the displayed vertical synchronization signal DVS by the manner of controlling the counter number of the display line counter DLC for delaying the occurrence of the pulse of the displayed vertical synchronization signal DVS. For example, if the displayed vertical synchronization signal DVS will be delayed for two pulses of the displayed horizontal synchronization signal DHS, then the display line counter DLC can be set to count from 2 at beginning such that the displayed vertical synchronization signal DVS can be delayed for two pulses of the displayed horizontal synchronization signal DHS (see the waveform DVS1 shown in FIG. 4). In another embodiment, the present invention can adjust the time interval of the displayed vertical synchronization signal DVS through a display pixel counter DPC (not shown). For example, if the displayed vertical synchronization signal DVS will be delayed for m-n pulses of the displayed clock signal DCLK, then the display pixel counter DPC can be set to count from n to m such that the displayed vertical synchronization signal DVS can be delayed for m-n pulses of the displayed clock signal DCLK. In this embodiment, it can be seen that a time interval between the pulse of the displayed vertical synchronization signal DVS and the data enable signal DEN as shown in FIG. 4 is variable, i.e. not constant, since the occurrence time of the pulse of the displayed vertical synchronization signal DVS can be adjusted with respect to the occurrence time of the data enable signal DEN.

In a preferred embodiment, although the frequency of the displayed vertical synchronization signal DVS1 is time-variable (not constant), the average frequency of the displayed vertical synchronization signal DVS1 is substantially kept identical to the frequency of the displayed vertical synchronization signal DVS. Accordingly, the depth of the FIFO memory will not be additionally increased such that the FIFO memory can prevent overflow or underflow problems. In such a manner, the output frame period can be time-variable and an average of the output frame period can be constant.

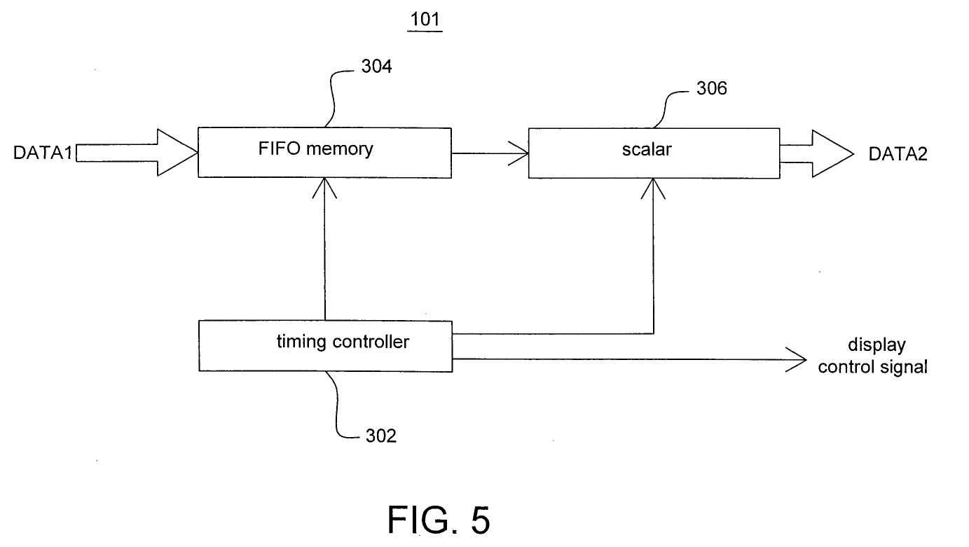

FIG. 5 is a block diagram for illustrating the inner circuit of a display control unit 101 according to another embodiment of the present invention. The display control unit 101 is used for transforming an image data signal DATA1 into an image data signal DATA2 and comprises a timing controller 302, a FIFO memory 304 and a scalar 306. The timing controller 302 is used for generating various timing signals and outputting a display control signal, e.g. the displayed vertical synchronization signal DVS. In this embodiment, the timing controller 302 can achieve the object of changing the time interval of the displayed vertical synchronization signal DVS by the manner of controlling the pulse number of the input horizontal synchronization signal IHS, the input clock signal ICLK, the displayed horizontal synchronization signal DHS or the displayed clock signal DCLK.

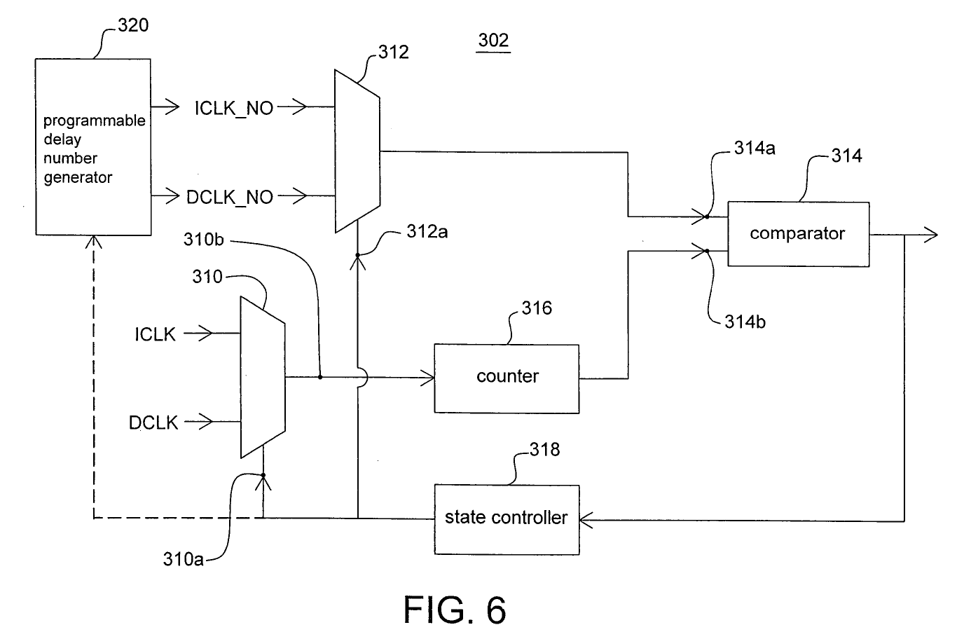

FIG. 6 is a schematic circuit of the timing controller 302 shown in FIG. 5. In this embodiment, the timing controller 302 can achieve the object of changing the time interval of the displayed vertical synchronization signal DVS by the manner of controlling pulse number of the input clock signal ICLK or the displayed clock signal DCLK for delaying the occurrence of the pulse of the displayed vertical synchronization signal DVS. The timing controller 302 comprises two multiplexer 310, 312, a comparator 314, a counter 316 and a state controller 318. The two inputs of the multiplexer 310 respectively receive an input clock signal ICLK and a displayed clock signal DCLK. The two inputs of the multiplexer 312 respectively receive a predetermined pulse number ICLK_NO and a predetermined pulse number DCLK_NO. The pulse number ICLK_NO is used for determining the pulse number of the input clock signal ICLK for which the displayed vertical synchronization signal DVS will be delayed with respect to the input vertical synchronization signal IVS; the pulse number DCLK_NO is used for determining the pulse number of the displayed clock signal DCLK for which the displayed vertical synchronization signal DVS will be delayed with respect to the input vertical synchronization signal IVS. In this embodiment, the pulse numbers ICLK_NO and DCLK_NO can be time-varying or preset.

In this embodiment, the timing controller 302 further comprises a programmable delay number generator 320 for outputting the predetermined pulse number ICLK_NO and the predetermined pulse number DCLK_NO to the two inputs of the multiplexer 312. In addition, the programmable delay number generator 320 can control the pulse number ICLK_NO and the pulse number DCLK_NO by the state controller 318. In an embodiment, the function of at least one of the state controller 318 and the programmable delay number generator 320 is similar to that of the pattern generator 108 in FIG. 3. That is, at least one of the output value of the state controller 318 and the output of the programmable delay number generator 320 is predetermined or pseudo-random or random. The output value comprises a plurality of values and each value is corresponding to the number of pulse of the clock signal.

One output of the state controller 318 is electrically connected to the select line 310a of the multiplexer 310 for selecting ICLK or DCLK to be outputted to the counter 316 from the output 310b. The output of the state controller 318 is also electrically connected to the select line 312a of the multiplexer 312 for selecting ICLK_NO or DCLK_NO to be outputted to the input 314a of the comparator 314 from the output of the multiplexer 312. The counter 316 counts the pulse number of the ICLK or the DCLK and then outputs its counted number to the other input 314b of the comparator 314. The comparator 314 is used for comparing the counted numbers of the ICLK_NO or DCLK_NO and ICLK or DCLK so as to determine whether the ICLK or DCLK has been equal to ICLK_NO or DCLK_NO or not and outputting a result signal to the state controller 318 according to the compared result. In an embodiment, if the ICLK or DCLK is equal to ICLK_NO or DCLK_NO, then the pulse of the displayed vertical synchronization signal DVS occurs. In an embodiment, the multiplexer 312 and the state controller 318 can be omitted when only one of the pulse numbers ICLK_NO and DCLK_NO is used.

It should be understood that the timing controller 302 as shown in FIG. 6 is only for illustration and should not be limited to this embodiment. Any other circuit having a similar function can also achieve the same object. For example, the inputs of the two multiplexer 310, 312 can receive any combination of the input horizontal synchronization signal IHS, the input clock signal ICLK, the displayed horizontal synchronization signal DHS, the displayed clock signal DCLK or their corresponding pulse numbers of IHS_NO, ICLK_NO, DHS_NO and DCLK_NO, which can also achieve the object of delaying the displayed vertical synchronization signal DVS.

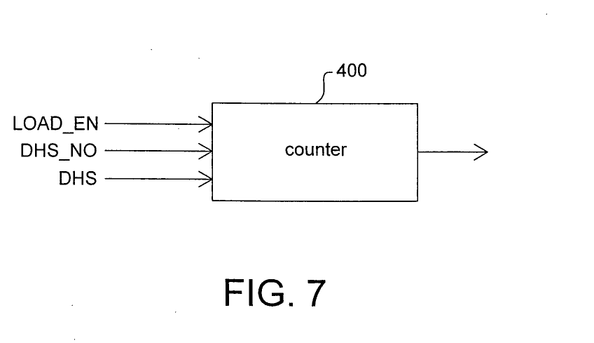

In another embodiment, when the counter 316 counts to a number equal to the predetermined pulse number, the state controller 318 will generate a load enable signal LOAD_EN and transmit it to a counter 400 as shown in FIG. 7 such that the counter 400 can load a pulse number DHS_NO and begin to count the pulse number of the displayed horizontal synchronization signal DHS from the pulse number DHS_NO.

The present invention provides a method for adjusting the time interval of the displayed vertical synchronization signal DVS, that is, changing the frame period thereby solving the problems existing in the prior art. However, the method can also be applied to any of the other display control signals, e.g. the displayed horizontal synchronization signal DHS.

It should be understood that the display controller of the present invention can be applied to various digital display device such as LCD devices, LCD panels, LCD TV, DTV, or PDP devices.

Although the invention has been explained in relation to its preferred embodiment, it is not used to limit the invention. It is to be understood that many other possible modifications and variations can be made by those skilled in the art without departing from the spirit and scope of the invention as hereinafter claimed.

What is claimed is:

1. A method, applied to a display controller for processing an input image signal which includes an input control signal and outputting an output image signal which includes an output synchronization signal having a first frequency, the method comprising:
delaying the output synchronization signal for a variable time according to a pattern and the input control signal such that the first frequency of the output synchronization signal is time-variable; and
outputting the delayed output synchronization signal.

2. The method of claim 1, wherein an average of the first frequency of the output synchronization signal is substantially constant.

3. The method of claim 1, wherein the input image signal has an input frame period and the output image signal has an output frame period, and an average of the input frame period is substantially equal to an average of the output frame period.

4. The method of claim 1, wherein the display controller is one of a LCD controller, a DTV controller, and a LCD TV controller.

5. The method of claim 1, wherein the output synchronization signal is one of a displayed vertical synchronization signal (DVS) and a displayed horizontal synchronization signal (DHS).

6. The method of claim 1, wherein the input control signal is one of an input vertical synchronization signal (IVS) and an input horizontal synchronization signal (IHS).

7. The method of claim 1, wherein the pattern is one of a predetermined pattern, a random pattern, and a pseudo-random pattern.

8. The method of claim 7, wherein the input image signal has an input frame period and the output image signal has an output frame period, and an average of the input frame period is substantially equal to an average of the output frame period.

9. An apparatus for controlling a display panel, comprising:
a display control unit for processing an image data, transmitting the processed image data to the display panel, and generating a first synchronization signal having a first time interval;
a programmable timing generator for generating a second synchronization signal according to the first synchronization signal, wherein the second synchronization signal has at least one time interval different from the first time interval of the first synchronization signal; and
a multiplexer for receiving the first synchronization signal and the second synchronization signal and selectively outputting one of them to the display panel according to a control signal;
wherein a display rate of the image data on the display panel is controlled according to the output signal of the multiplexer.

10. The apparatus of claim 9, wherein the display controller is one of a LCD controller, a DTV controller, and a LCD TV controller.

11. The apparatus of claim 9, wherein the first synchronization signal is one of a displayed vertical synchronization signal (DVS) and an input vertical synchronization signal (IVS).

12. The apparatus of claim 11, wherein the second synchronization signal is a delayed displayed vertical synchronization signal having a delay time with respect to the first synchronization signal.

13. The apparatus of claim 9, wherein the display control unit outputs a data enable signal (DEN), and a time interval between the second synchronization signal and the data enable signal is variable.

14. The apparatus of claim 9, wherein an average time interval of the second synchronization signal is substantially equal to a time interval of the first synchronization signal.

15. The apparatus of claim 9, further comprising:
a pattern generator coupled to the multiplexer for generating the control signal to the multiplexer according to a pattern.

16. The apparatus of claim 15, wherein the pattern is one of a predetermined pattern, a random pattern, and a pseudo-random pattern.

17. A display controller for processing an input image signal, which includes an input control signal and an input data signal, and for outputting an output image signal which includes an output synchronization signal and an output data signal, the display controller comprising:
a buffer for storing the input data signal;
a scalar coupled to the buffer for scaling the input data signal so as to generate the output data signal; and
a timing controller coupled to the buffer and the scalar for changing a time interval of the output synchronization signal according to the input control signal and a pattern;
wherein the output synchronization signal has a frequency which is time-variable.

18. The display controller of claim 17, wherein the input control signal is a clock signal, the pattern comprises a plurality of pattern values, and each pattern value is corresponding to the number of pulses of the clock signal.
